(19) United States
(12) Patent Application Publication
(10) Pub. No.: US 2026/0353466 A1
(43) Pub. Date: Nov. 5, 2026

(54) INDICATING INFORMATION IN RANDOM ACCESS PROCEDURE

(71) Applicant: InterDigital Patent Holdings, Inc., Wilmington, DE (US)

(72) Inventors: Samuli Turtinen, Ii (FI); Faris Alfarhan, Montreal (CA); Tuong Hoang, Montreal (CA); Francois Periard, Montreal (CA); Martino Freda, Laval (CA); Brian Martin, Farnham (GB); Keiichi Kubota, Setagaya-Ku (JP); Diana Pani, Montreal (CA); Ghyslain Pelletier, Montreal (CA); Paul Marinier, Brossard (CA); Chia-Hung Wei, Chesterbrook, PA (US)

(73) Assignee: InterDigital Patent Holdings, Inc., Wilmington, DE (US)

(21) Appl. No.: 19/199,041

(22) Filed: May 5, 2025

(51) Int. Cl. H04W 74/0833; H04B 17/318

(52) U.S. Cl. CPC H04W 74/0833; H04B 17/328

(57) ABSTRACT

Systems, methods, and instrumentalities for indicating information in random access (RA) procedure(s) are disclosed herein. A wireless transmit/receive unit (WTRU) (e.g., a processor thereof) may receive, from a network, a configuration of one or more random access (RA) formats. A (e.g., each) RA format may be associated with a respective preamble and a respective payload. The WTRU may detect an RA trigger condition. The WTRU may select, based on one or more of the detected RA trigger condition or the received configuration, an RA format of the one or more RA formats. The WTRU may determine a content of the payload associated with the selected RA format. The WTRU may transmit, to the network, the preamble and the payload associated with the selected RA format.

### BACKGROUND

New Radio (NR) may partition random access preambles for various uses. One or more (e.g., all) of the partitions may be configured beam (e.g., SSB/CSI-RS) specifically. Feature combinations may exponentially grow the number of required RACH configs. Furthermore, 6G is envisioned to create even more device types/features which may need to be identified early by the network during the access to be able to serve a (e.g., each) wireless transmit/receive unit (WTRU) according to its capabilities. This means that the preamble partitioning is not a practical solution as done in NR to be implemented and widely deployed. Methods and apparatuses to enable indicating various information (e.g., used feature, device type, access type, etc.) to the network during the RA procedure without extensive preamble partitioning may be needed.

### SUMMARY

Systems, methods, and instrumentalities for indicating information in random access (RA) procedure(s) are disclosed herein. One or more of the methods disclosed herein may be implemented by a wireless transmit/receive unit (WTRU) and/or by a UE, for example via a processor thereof. A WTRU may receive, from a network, a configuration of one or more random access (RA) formats (e.g., Msg1 formats). A (e.g., each) RA format may be associated with a respective preamble and a respective payload. A (e.g., each) RA may be associated with one or more of: a respective payload size, a respective payload encoding format, or a respective physical channel. The WTRU may detect an RA trigger condition. For example, the trigger condition may the RA trigger condition be one or more of the WTRU determining that the WTRU has new data to transmit, a paging receival, or a handover. The WTRU may select, based on one or more of the detected RA trigger condition or the received configuration, an RA format of the one or more RA formats. The WTRU may determine a content of the payload associated with the selected RA format, for example based on respective priorities of pieces of information to be included in the payload. The content of the payload may include one or more of a Cell Radio Network Temporary Identifier (C-RNTI) associated with the WTRU, a Msg3 repetition request, a Msg3 size requirement, a device type associated with the WTRU, an RRC state associated with the WTRU, or a type of access, and may be included in the payload in the form of a bitmap. The WTRU may transmit, to the network, the preamble and the payload associated with the selected RA format. The WTRU may select transmission resources for the preamble and the payload (e.g., based on one or more of applicable beams, a type of beam, a payload size of the small payload part, or information to be indicated in the small payload part), and the preamble and payload may be transmitted using the selected transmission resources. The WTRU may determine that a measured downlink (DL) reference signal received power (RSRP) is below a threshold, and the RA format may be selected based on the RA format having a minimum payload size among the one or more RA formats.

The WTRU may transmit a two-piece RA Msg1 consisting of a preamble and a (e.g., small) payload to a network. The payload may be used to indicate various information with regard to the WTRU access. A Msg2 (RAR) from the network may be scheduled based on the received information, and may be used to perform contention resolution for the Msg1. A Msg3/MsgA (e.g., first) subheader in a MAC PDU may have a specific format distinct from the remainder of the MAC PDU. An extendible RAR MAC PDU format may be introduced where both the RAR subheader and the payload (e.g., or at least the payload) may have a flexible length.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates examples of RAR subheader formats.

FIG. 3 illustrates an example of a subheader.

FIG. 4 illustrates an example proposed RA procedure.

FIG. 5 illustrates an example procedure for indicating information in random access.

### DETAILED DESCRIPTION

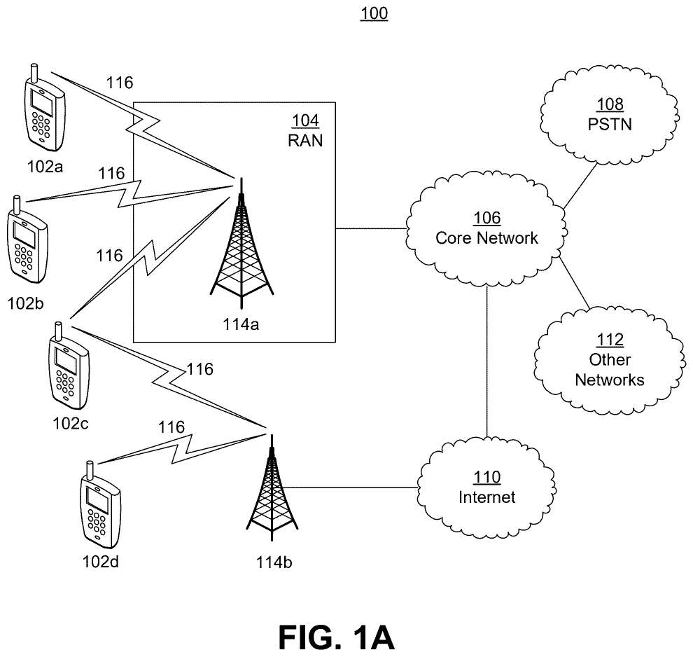

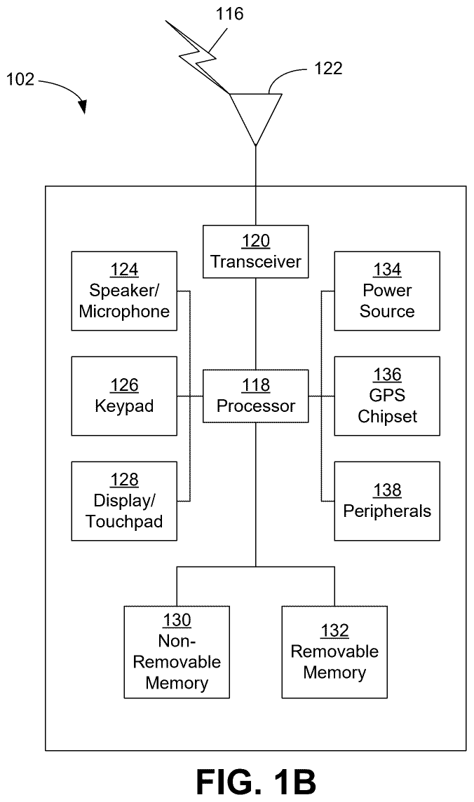

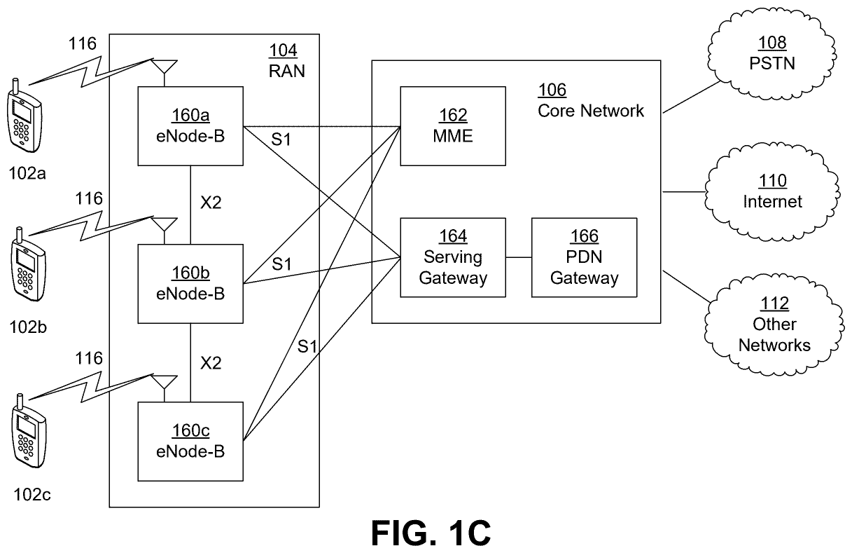

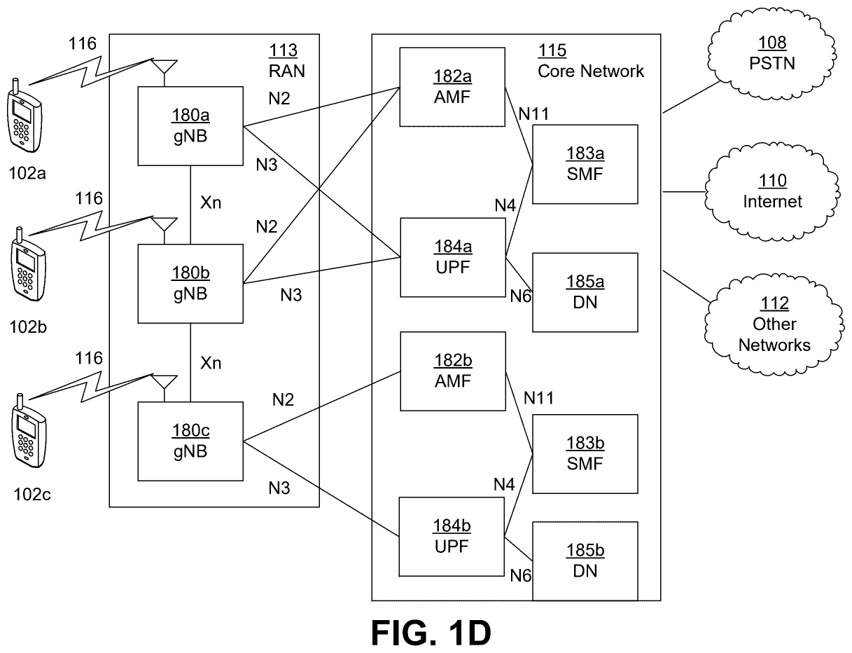

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A random access (RA) procedure in new radio (NR) may be triggered for a number of events: initial access from RRC_IDLE; RRC Connection Re-establishment procedure; DL or UL data arrival, during RRC_CONNECTED or during RRC_INACTIVE while small data transmission (SDT) procedure is ongoing, when UL synchronization status is “non-synchronized”; UL data arrival, during RRC_CONNECTED or during RRC_INACTIVE while SDT procedure is ongoing, when there are no PUCCH resources for SR available; handover, except for when RACH-less HO (Handover) is configured; SR failure; explicit request by RRC upon synchronous reconfiguration; RRC Connection Resume procedure from RRC_INACTIVE; to establish time alignment for a primary or a secondary TAG; request for Other SI (System Information); beam failure recovery; consistent UL LBT failure on SpCell; SDT in RRC_INACTIVE; positioning purpose during RRC_CONNECTED requiring random access procedure, e.g., when timing advance is needed for WTRU positioning; early UL synchronization with an LTM (Lower-layer Triggered Mobility) candidate cell; RACH-based LTM cell switch, etc.

Additionally, the network may associate a set of RACH resources with feature(s) applicable to a Random Access procedure: Network Slicing, (e)RedCap, SDT, and/or NR coverage enhancement (e.g., Msg1 or Msg3 repetition request). A set of RACH resources associated with a feature may (e.g., only) be valid for random access procedures applicable to at least that feature. A set of RACH resources associated with several features may (e.g., only) be valid for random access procedures having one or more of (e.g., all of) these features. The wireless transmit/receive unit (WTRU) may select the set(s) of applicable RACH resources, after uplink carrier (e.g., NUL or SUL) and BWP selection, and before selecting the RA type.

An (e.g., the only) option to support many of the feature indications in NR may be preamble partitioning (e.g., RA preamble indicates the feature (set)): Common RACH (e.g., used for regular RA); SI request; Beam failure recovery (e.g., only WTRU dedicated CFRA preambles); SDT; network slicing; (e)RedCap; Msg1 repetitions (e.g., RA preamble repetitions); Msg3 repetition request; Preambles group B; and/or NW allocated CFRA preambles, e.g., for HO (e.g., including LTM), DL data arrival, positioning purpose, and early UL sync with an LTM candidate cell.

If multiple (e.g., two or more) of the features described herein are intended to be supported concurrently in the cell, separate preambles for a feature group may need to be configured (e.g., SDT resources for RedCap WTRUs).

Additionally, NR may support indications of some features, like SI request, (e)RedCap device identification, and/or Msg4 PUCCH ACK repetition request through Msg3 of the RA procedure (e.g., different LCID values used to indicate CCCH SDU in the Msg3 are allocated to indicate the feature, except for SI request for which separate RRC message is used).

Methods, systems, and instrumentalities may be disclosed herein for enabling indication of various information (e.g., used feature, device type, access type, etc.) to the network during the RA procedure without extensive preamble partitioning. One or more of the methods disclosed herein may be implemented in a WTRU and/or a UE, for example via a processor thereof.

New Radio (NR) may partition random access preambles for various uses. One or more (e.g., all) of the partitions may be configured beam (e.g., SSB/CSI-RS) specifically. Feature combinations may exponentially grow the number of required RACH configs. Furthermore, 6G is envisioned to create even more device types/features which may need to be identified early by the network during the access to be able to serve a (e.g., each) wireless transmit/receive unit (WTRU) according to its capabilities. This means that the preamble partitioning is not a practical solution as done in NR to be implemented and widely deployed.

A WTRU may transmit a two-piece RA Msg1 consisting of a preamble and a small payload to the network, where the small payload may be used to indicate various information regarding the WTRU access. Msg2 (RAR) from network may be scheduled based on the received information, and may be used to perform contention resolution for the Msg1.

The WTRU may be configured with multiple random access (RA) Msg1 formats, a (e.g., each) Msg1 format including a preamble and a payload (e.g., small payload part). A (e.g., each) format may further be associated with a set of conditions. A (e.g., each) small payload part format may include one or more of, for example, payload size, payload encoding format, physical channel to be transmitted (e.g., PUSCH/PUCCH), etc. Small payload part format conditions may include one or more of, for example, WTRU type, WTRU connection state (e.g. RRC state), WTRU capabilities, RA trigger, amount of information to be indicated to the network, channel conditions (e.g., RSRP/RSRQ), etc.

The WTRU may detect an RA trigger condition (e.g., new data to transmit, paging receival, handover, etc.).

The WTRU may select the small payload part format based on the conditions and the configuration. For example, a small payload part format with minimum payload may be selected when the measured DL RSRP is below a configured threshold level. The WTRU may need to prioritize the information it indicates as part of the small payload part. For example, the WTRU may prioritize information that may affect network decisions relating to the remainder of the RA procedure (e.g., Msg3 repetition requirement, WTRU capabilities to decode RAR, etc.). A small payload part format for C-RNTI indication may be selected when the WTRU determines to be in CONNECTED mode and the RA trigger is for handover or UL data arrival.

The WTRU may determine the content of the payload (e.g., small payload part) based on the format and/or information to be indicated to the network. For example, the WTRU may encode its C-RNTI into the small payload part for the format used to indicate the C-RNTI or for the format which has a payload size large enough at least to include the C-RNTI. For example, the WTRU may encode a bitmap in the small payload part based on the information to be indicated, the information including, for example, Msg3 repetition request, Msg3 size (e.g., based on CCCH SDU size) requirement, device type, RRC state, type of access (e.g., SDT), etc.

The WTRU may select the RA and small payload part transmission resources based on one or more of: applicable beams (e.g., in terms of beam channel conditions based on RSRP/RSRQ/etc.); a type of beam (e.g., SSB or CSI-RS based); the selected payload size for the small payload part; and/or the information to be indicated in the small payload part.

The WTRU may transmit the Msg1 (e.g., the RA preamble and associated small payload part) using the selected resources.

Various information about WTRU device type, type of access, feature, capabilities, etc. may be transmitted in Msg1 without extensive preamble partitioning.

RA procedure initialization may be performed. A WTRU may initiate a RA procedure based on a trigger condition. Such trigger condition (e.g., based on 5G) may include, for example, one or more of: Initial access from RRC_IDLE; RRC Connection Re-establishment procedure; DL or UL data arrival, during RRC_CONNECTED or during RRC_INACTIVE while SDT (Small Data Transmission) procedure is ongoing, when UL synchronisation status is “non-synchronised”; UL data arrival, during RRC_CONNECTED or during RRC_INACTIVE while SDT procedure is ongoing, when there are no PUCCH resources for SR available; handover; SR failure; an explicit request by RRC upon synchronous reconfiguration; RRC Connection Resume procedure from RRC_INACTIVE; to establish time alignment for a primary or a secondary TAG; a request for Other SI (System Information) or on-demand SIB1; Beam failure recovery; Consistent UL LBT failure; SDT in RRC_INACTIVE; Positioning purpose during RRC_CONNECTED requiring random access procedure, e.g., when timing advance is needed for WTRU positioning; Early UL synchronization with an LTM candidate cell; etc.

The trigger condition may be initiated by the NW or by the WTRU itself.

Upon initiation of the RA procedure, the WTRU may initialize a number of parameters and variables for the RA procedure. Such parameters and variables (e.g., based on 5G) may include, for example, a PRACH configuration (e.g., prach-ConfigurationIndex, msgA-PRACH-ConfigurationIndex, preambleReceivedTargetPower, msgA-PreambleReceivedTargetPower, etc.); Beam selection RSRP thresholds (e.g., rsrp-ThresholdSSB, rsrp-ThresholdCSI-RS, msgA-RSRP-ThresholdSSB, rsrp-ThresholdSSB-SUL, rsrp-ThresholdMsg1-RepetitionNum2, rsrp-ThresholdMsg1-RepetitionNum4, rsrp-ThresholdMsg1-RepetitionNum8, etc.); RA type selection RSRP thresholds (e.g., msgA-RSRP-Threshold, rsrp-ThresholdMsg3, etc.); RA procedure related parameters (e.g., featurePriorities, msgA-TransMax, candidateBeamRSList, recoverySearchSpaceId, powerRampingStep, msgA-PreamblePowerRampingStep, powerRampingStepHighPriority, scalingFactorBI, ra-PreambleIndex, ra-ssb-OccasionMaskIndex, msgA-SSB-SharedRO-MaskIndex, ssb-SharedRO-MaskIndex, ra-OccasionList, ra-PreambleStartIndex, preambleTransMax, preambleTransMax-Msg1-Repetition, ssb-perRACH-OccasionAndCB-PreamblesPerSSB, msgA-CB-PreamblesPerSSB-PerSharedRO, msgA-SSB-PerRACH-OccasionAndCB-PreamblesPerSSB, numberOfPreamblesPerSSB-ForThisPartition, msgA-PUSCH-ResourceGroupA, msgA-PUSCH-ResourceGroupB, msgA-PUSCH-Resource-Index, ra-Msg3SizeGroupA, msg3-DeltaPreamble, messagePowerOffsetGroupB, numberOfRA-PreamblesGroupA, msgA-DeltaPreamble, messagePowerOffsetGroupB, numberOfRA-PreamblesGroupA, ra-MsgA-SizeGroupA, the set of Random Access Preambles and/or PRACH occasions for SI request (e.g., if any), the set of Random Access Preambles and/or PRACH occasions for beam failure recovery request (e.g., if any), the set of Random Access Preambles and/or PRACH occasions for handover (e.g., if any), ra-ResponseWindow, ra-ContentionResolutionTimer, msgB-ResponseWindow, etc.); and/or RA procedure variables (e.g., PREAMBLE_INDEX, PREAMBLE_TRANSMISSION_COUNTER, PREAMBLE_POWER_RAMPING_COUNTER, PREAMBLE_POWER_RAMPING_STEP, PREAMBLE_RECEIVED_TARGET_POWER, PREAMBLE_BACKOFF, PCMAX, SCALING_FACTOR_BI, TEMPORARY_C-RNTI, RA_TYPE, POWER_OFFSET_2STEP_RA, MSGA_PREAMBLE_POWER_RAMPING_STEP, etc.).

Configuration of payload (e.g., small payload part) format may be disclosed herein.

The WTRU may receive a configuration (e.g., through RRC signaling) for the small payload part of Msg1. Such configuration may include, for example, time/frequency resources; an association with the preambles; a transmit power configuration; sizes and/or formats of small payloads; an encoding configuration for the small payload; etc.

The configuration may include an association with the preambles. A (e.g., each) small payload part may be associated with a single preamble or multiple preambles. A preamble may be associated with a certain size of small payload. For example, there may be one or more different size of small payloads, and the preamble may indicate to the NW the size of the small payload part the WTRU transmits. The preambles associated with the small payload part may be distinct from the “Common RACH” (e.g., which may be used for general RA (without additional information indicating)).

The small payload part may consist of, e.g., 1-3 bytes. The small payload part size may be configured by the network. For example, the small payload part size may be (e.g., always) the same size (e.g., 2 bytes), or the WTRU may indicate the size of the small payload part. The WTRU indication may be based on the transmitted preamble (e.g., different preambles correspond to different payload size) or UCI (Uplink Control Information) may be encoded into the small payload part to indicate the actual payload size.

The small payload part may be encoded and transmitted over PUSCH (Physical Uplink Shared Channel) or PUCCH (Physical Uplink Control Channel) resource, and may be transmitted in TDM or FDM manner with the preamble. In another example, the small payload part may be encoded and transmitted in a newly defined physical channel.

The WTRU may determine the content of the payload (e.g., small payload part) based on the format and the information to be indicated to the network.

The WTRU may be configured to determine the set of relevant information that the WTRU has to indicate to the network, for example using the small payload part. The relevant set of information to indicate may be determined, for example, based on one or more of: a type of the device (e.g., RedCap, IoT, LPWA (Low Power Wide Area), XR (eXtra Reality)); channel conditions (e.g., RSRP, RSRQ, SINR); a type of the access (e.g., initial access, resume, scheduling request, beam failure recovery, small/bursty data transmission, SI request, handover, etc.); a payload size (e.g., for Msg3 transmission, or buffer size), requested service (e.g., specific network slice (set), Msg3 repetition request, etc.), or any other information; and/or a WTRU state, e.g., in terms of RRC states (RRC_IDLE, RRC_INACTIVE, or RRC_CONNECTED). There may be different channel condition configuration per type of the device.

The WTRU may be configured to determine the content of the small payload part based on the WTRU RRC state. For example, in RRC_IDLE state (e.g., or its equivalent) the WTRU may be configured to include the type of device, whereas in RRC_CONNECTED state the WTRU may instead include the requested service (e.g. if new service is added) or its C-RNTI.

The WTRU may be configured to determine the content of the small payload part based on channel conditions, e.g., in terms of RSRP and configured RSRP threshold(s) level(s). For example, if the measured RSRP is below a RSRP threshold (e.g., smallest RSRP threshold), the WTRU may determine to select the small payload part with smallest size of payload.

If the WTRU determines that the small payload part cannot encode all the determined information, the WTRU may prioritize the information to be indicated. For example, the device type may be of highest priority to be indicated and the potential payload size may be the lowest priority to be indicated, or vice versa.

RA resource selection may be performed. The Msg1 transmission may include a preamble part and a small payload part. The WTRU may select an RA resource for Msg1 transmission based on one or more configured small payload formats, one or more conditions, and/or information to be indicated.

The WTRU may select the format/size of the small payload part based on the amount of information determined to be indicated. Channel conditions (e.g., based on RSRP, RSRQ, SINR) may be accounted for in determining the format/size of the small payload part the WTRU selects.

The WTRU may select the preamble part of Msg1 randomly, and the small payload part may be determined based on the selected preamble. The small payload part may be selected randomly from the set of the small payload parts on the selected format, and the preamble part may be determined based on the selected small payload part. Both the preamble and the small payload part transmission resources may be selected randomly, and the WTRU may indicate within the small payload the preamble ID it used to transmit the Msg1.

Different small payload part formats may be used to indicate different information. The WTRU may select the preamble and small payload part based on the information it indicates to the network.

If the WTRU requires Msg1 repetition (e.g., determined based on channel conditions), the WTRU may select a PRACH resource (e.g., RO (RACH Occasion), preamble, etc.) first. The small payload part may be scheduled by the NW after the preamble reception is successful based on the preamble repetition. Both the preamble and the small payload part may be transmitted with repetitions.

The Msg1 resource selection may depend on the state in which the WTRU currently is, for example, in terms of RRC states (e.g., RRC_IDLE, RRC_INACTIVE, RRC_CONNETED).

If the WTRU has no specific information to be indicated to the network as part of the RA procedure, the WTRU may select RA resources that are not associated with the small payload parts (e.g., “Common RACH” resources). A set of RA resources may not be associated with small payload parts in the cell/system; or vice versa, another set of RA resources may be associated with the small payload parts.

Msg1 small payload information may be disclosed herein. The WTRU may encode the payload (e.g., small payload part) with the information to be indicated to the network device.

The payload (e.g., small payload part) may consist of a bitmap, a field with assignable indices, or both. Additionally, the small payload part may additionally consist of reserved bits (e.g., for future use). For example, information that may be associated with any other information in the small payload may be assigned a separate bit in a bitmap. In an example, Msg3 repetition request may be such information, CCCH SDU size, or device type.

The bitmap may be used to indicate one or more distinct pieces of information at the same time. For example, the WTRU may indicate the requirement/request for Msg3 repetitions, a specific device type (e.g., XR or RedCap device), and the type of the access (e.g., SDT), and may encode the bitmap accordingly.

A field may be encoded where certain index of the field indicates certain information. For example, the index of the field may indicate the state of the WTRU (e.g., CONNECTED or IDLE/INACTIVE). The index of the field may indicate the required payload size for the Msg3 (e.g., minimum of 56 bits, 72 bits, etc.).

A field/bit may be encoded which indicates the format of the remainder of the small payload part. For example, the field/bit may indicate that the WTRU is a CONNECTED mode WTRU, and the WTRU's C-RNTI may be encoded in the remainder of the payload part. The preamble used for Msg1 transmission may indicate that the WTRU is in RRC_CONNECTED state and the small payload part directly encodes the WTRU's C-RNTI.

The WTRU may generate a random number into the small payload part. The random ID may be, e.g., a 1-5 bits long field.

The NW may configure at least partly how the small payload is encoded by the WTRU (e.g., indicate the bitmap/index values to be used for specific information). For example, certain network nodes may not support all the features specified and may configure, based on its capabilities, how the information is to be encoded into the small payload.

Random access response monitoring and reception may be performed.

After the WTRU transmits the two-piece Msg1, it may start a RAR (Random Access Response) window and may start to monitor for RAR.

The RAR window may be started immediately after the two-piece Msg1 transmission, after the preamble transmission, or after an offset time after the two-piece Msg1/preamble transmission. The RAR window starting may also depend on the system where the WTRU transmits the preamble (e.g., whether it is a terrestrial network (TN) or non-terrestrial network (NTN)).

The RAR window starting/monitoring may be based at least in part on the information indicated in the two-piece Msg1. For example, based on the information indicated in the two-piece Msg1, the WTRU may decode the RAR window for a specific time duration; the WTRU may decode the RAR within a specific frequency (e.g., bandwidth part); the WTRU may decode a specific RNTI (Radio Network Temporary Identifier); the WTRU may apply a specific bandwidth; etc.

The RAR may be monitored through PDCCH with a specific RNTI.

If the WTRU includes C-RNTI in the small payload part of Msg1, the WTRU may monitor for the RAR based on the C-RNTI. Otherwise, the WTRU may monitor for the RAR based on a RA-RNTI. The WTRU may monitor for the RAR based on a RA-RNTI (e.g., always), or based on both the C-RNTI and RA-RNTI.

Upon receiving a RAR, the WTRU may determine if the RAPID (Random Access Preamble ID) the WTRU transmitted is included in the RAR PDU (the RAR PDU may be, e.g., a MAC PDU with a specific format for RAR). Furthermore, upon determining that the transmitted RAPID is included in the RAR PDU, the WTRU may further determine additional information associated with the RAPID, the additional information corresponding to at least part of the information transmitted by the WTRU in the small payload part.

The additional information may consist of the random ID generated randomly by the WTRU into the small payload part; the small payload the WTRU transmitted in the Msg1 (e.g., NW echoes the whole small payload in the RAR); part of the small payload the WTRU transmitted in the Msg1, etc.

If the WTRU includes its C-RNTI in the small payload part of Msg1, the WTRU may decode C-RNTI for RAR and upon receiving a PDCCH addressed to C-RNTI, the WTRU may determine the RAR reception and the whole RA procedure successfully completed. The WTRU may expect to receive DL assignment if the WTRU has no valid TA (Timing Alignment). The WTRU may expect to receive UL grant if the WTRU has a valid TA.

If the WTRU includes its C-RNTI in the small payload part, the WTRU may decode corresponding RA-RNTI for RAR, and upon receiving the RAR MAC PDU with used RAPID, the WTRU may determine if the indicated TC-RNTI in the RAR payload corresponds to the indicated C-RNTI. If the TC-RNTI matches with indicated C-RNTI, the WTRU may consider the RAR reception, contention resolution, and RA procedure successfully completed.

The RAR MAC PDU format may be used where both of the RAR subheader as well as the payload (e.g., or at least the payload) may have flexible length.

The RAR subheader may include a field indicating the RAR payload size. For example, the field may be 1 or 2 bits long indicating 2 or 4 RAR payload sizes, respectively.

The RAR subheader may be 1 or 2 bytes long depending on an indication in the RAR subheader. The indication may be a field indicating a subheader type. For example, 2 bits field may indicate 4 different subheader formats, e.g., RAPID only (e.g., for 2-step fallbackRAR or 4-step RAR); RO indication; SuccessRAR/padding; 2-byte subheader; etc. For RO indication, the RARs after the RO indication may be (e.g., all) for that RO until a second RO indication is encoded in the RAR MAC PDU, or end of the MAC PDU is reached. A backoff indicator (BI) may also follow this indication to apply BI per RO. A default RAR format and/or size may be defined for the RAPID-only case.

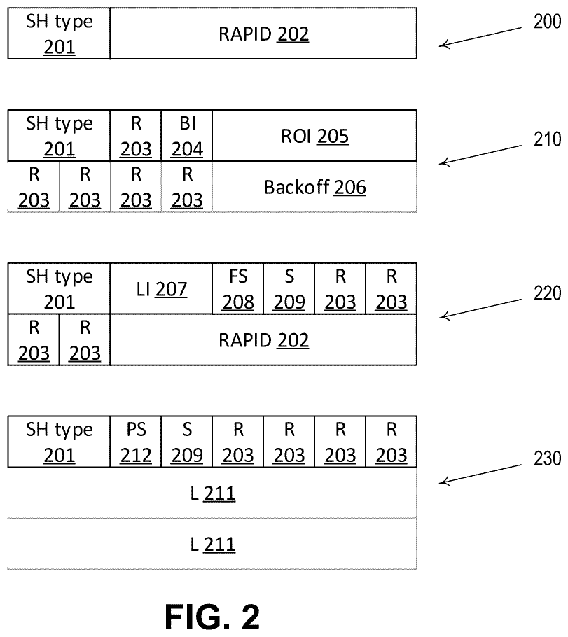

The RAR subheader formats may be as shown in FIG. 2. FIG. 2 illustrates examples of RAR subheader formats.

As shown in FIG. 2, the term “SH type 201” may indicate the type of the subheader in RAR: subheader 200 with a “default” RAR/fallbackRAR with fixed RAR size which indicates the preamble ID 202 and the default size RAR payload; an ROI (RO indicator) 205 subheader 210 with possible backoff indicator (BI) 204 per RO (e.g., 1 or 2 byte subheader depending on BI 204); a subheader 220 with a different length (or type) RAR size based on LI (Length Indicator) 207 which may then include either RAR/fallbackRAR or successRAR (FS) 208; and/or a padding/“default” successRAR subheader 230 where a PS (padding/success) bit 212 may indicate which is encoded.

For ROI (RO indicator) 205 subheader 210 with possible backoff indicator (BI) 204 per RO, if BI 204 indicates presence of the Backoff field 206 for this RO, the second byte may be encoded. The ROI 205 may indicate the frequency domain RO index of a PRACH timeslot. Additionally/alternatively, the ROI 205 or an additional field may indicate the UL carrier used to transmit the PRACH. The subheader 210 may include one or more reserved (R) bits 203.

For subheader 220 with a different length (or type) RAR size based on LI (Length Indicator) 207 which may then include either RAR/fallbackRAR or successRAR (FS) 208, if successRAR is encoded based on FS 208, then the second byte may not be encoded. The LI 207 may indicate different RAR payload sizes, where the size values may depend on whether the RAR is a successRAR, fallbackRAR, or normal RAR. The RAR payload sizes may be the same for RAR and fallbackRAR. The subheader 220 may include one or more reserved (R) bits 203 and/or an S bit 209 indicating possible SDUs, and/or a preamble ID 202.

For padding/“default” successRAR subheader 230 where a PS (padding/success) bit 212 may indicate which is encoded, “S” bit 209 shown in FIG. 2 may indicate possible SDU(s) following the successRAR (e.g., as in legacy). The “L” field 211 may follow (e.g., or is indicated to follow) the first byte in case SDU(s) to multiple WTRUs are encoded in the RAR MAC PDU. The subheader 230 may include one or more reserved (R) bits 203 and/or an S bit 209 indicating possible SDUs.

The backoff information in the RAR PDU may be provided for each feature/device type/capability separately. For example, the NW may indicate backoff for RedCap devices (e.g., only).

Msg1 contention resolution may be performed. The WTRU may determine if the additional information corresponds to at least part of the information transmitted by the WTRU in the small payload part. For example, the additional information may be the additional information associated with RAPID, and may correspond to at least part of the information transmitted by the WTRU in the payload (e.g., small payload part). The additional information may be the network echoing, for example, the random ID generated for the payload, the (e.g., entire) payload, etc.

If the WTRU determines the additional information corresponds to at least part of the information transmitted by the WTRU in the small payload part, the WTRU may determine the RAR reception to be successful and may decode the actual RAR payload. The RAR payload may consist of, e.g., Msg3 grant information, TC-RNTI, Timing Advance Command, power control information, etc.

If the WTRU determines the additional information does not correspond to the information transmitted by the WTRU in the small payload part, the WTRU may determine RAR reception to be not successful and may initiate the RA resource selection again. The small payload part may be stored in a buffer upon first transmission (e.g., “Msg1 buffer”, “small payload buffer”, etc.) and the same payload may be used for a (e.g., each) re-attempt. Alternatively, the small payload part may (e.g., always) be regenerated upon a (e.g., every) re-attempt. The WTRU may selectively (e.g., only) store part of payload in the Msg1 buffer (e.g., or small payload buffer) and/or discard part of the information in the small payload. For example, the WTRU may store any information regarding the WTRU device type, type of access, feature and/or capabilities. The WTRU may discard the information regarding the random ID generated randomly by the WTRU. For example, the WTRU may regenerate a random ID to be included in the small payload to be transmitted upon a (e.g., every) re-attempt.

If the WTRU determines the additional information does not correspond to the information transmitted by the WTRU in the small payload part, the WTRU may still proceed to Msg3 transmission (e.g., without the NW knowing the information the WTRU transmitted in the small payload part). This behavior may be subject to the Msg3 size being large enough to include the information the WTRU indicated in the small payload part. This behavior may be subject to the information indicated in the small payload part. For example, if the WTRU indicated the common control channel (CCCH) SDU size in the small payload part and the Msg3 grant size is large enough to convey the CCCH SDU, the WTRU may proceed directly to the Msg3 transmission. The CCCH SDU may include an RRC Establishment Request, RRC Resume Request, RRC Re-Establishment Request, or System Information Request. The WTRU may not proceed to the Msg3 transmission if the WTRU requested for Msg3 repetitions in the small payload part and the NW did not schedule the Msg3 with repetitions.

Msg3 encoding and transmission may be disclosed herein. The WTRU may transmit the Msg3 based on the RAR content. The Msg3 may include further information to be indicated to the network during the RA procedure (e.g., Msg4 PUCCH ACK repetition request), e.g., information that was not indicated in the small payload part.

The WTRU (e.g., or the MAC entity of the WTRU) may encode the MAC PDU transmitted as part of a RA procedure differently from the UL-SCH MAC PDU. More specifically, the MAC PDU is transmitted as Msg3 after receiving a RAR (e.g., with 4-step RA procedure) or as MsgA PUSCH (e.g., with 2-step RA procedure).

A subheader (e.g., the first subheader) in the MAC PDU may have a specific format. Any other subheader (e.g., following the first subPDU) (e.g., MAC subheader +SDU/CE) in the MAC PDU may follow the UL-SCH MAC PDU format.

The specific format may consist of a field indicating whether a CCCH SDU or a C-RNTI MAC CE is encoded in the subPDU (e.g., follows the subheader). The field may be 1 bit indicating either CCCH SDU or C-RNTI MAC CE. The field may be 2 bits indicating either C-RNTI MAC CE or different sizes of CCCH SDU (e.g., 48 bits or 64 bits CCCH SDU). The remaining (e.g., one) index may be reserved or may indicate a subheader extension if the C-RNTI MAC CE is included in the subPDU. The remaining (e.g., one) index may indicate that the C-RNTI MAC CE precedes/follows with additional information, like security information (e.g., MAC-I or short MAC-I).

The specific format may consist of a field or bitmap indicating different information to the NW. The information may consist of one or more of the following. The field or the bitmap may indicate device type, repetition request for Msg4 PUCCH ACK/Msg5, small CSI, etc. The field may indicate a CCCH SDU extension. For example, 4-6 additional bits of the subheader may be used as CCCH SDU information extension which may indicate, e.g., a part of the WTRU ID, access cause, capabilities, etc. The field or the bitmap may be encoded differently based on whether the CCCH SDU or the C-RNTI MAC CE is included in the subPDU. For example, if C-RNTI MAC CE is included in the subPDU, one or more fields or bitmaps may indicate the RA cause (e.g., BFR, SR/BSR, SR failure, HO, etc.).

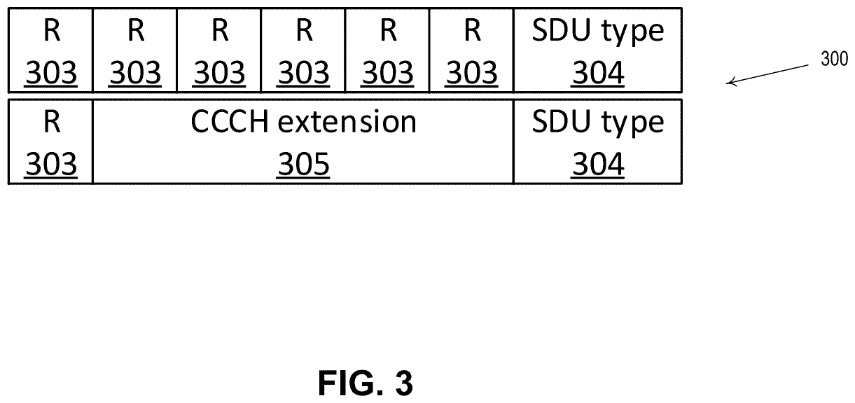

For example, a (e.g., first) subheader 300 may be illustrated as shown in FIG. 3. FIG. 3 illustrates an example of a subheader 300. The SDU type 304 shown in FIG. 3 may indicate the C-RNTI, CCCH SDU (with different sizes), etc. The R bits 303 shown in FIG. 3 may be used for the field or the bitmap. The subheader 300 may include a CCCH extension field 305.

Contention resolution may be performed. A WTRU may receive a contention resolution message. The contention resolution message may be addressed to the TC-RNTI assigned in the RAR, and may provide a contention resolution ID matching at least in part the CCCH SDU transmitted by the WTRU in Msg3.

A subheader (e.g., the first subheader) in the MAC PDU used by the NW for contention resolution (e.g., Msg4 in 4-step RA procedure or MsgB in 2-step RA procedure) may have a specific format. For example, the MAC PDU addressed to TC-RNTI assigned during the RA procedure may have the specific format for the (e.g., first) subheader in the MAC PDU (e.g., when 4-step RA procedure is used). The MAC PDU addressed to RA/MSGB-RNTI derived based on the transmitted MSGA (e.g., based on preamble or the PUSCH resource or both) may have the specific format for the (e.g., first) subheader in the MAC PDU (e.g., when 2-step RA procedure is used). Any other subheader (e.g., following the first subPDU) (e.g., MAC subheader+SDU/CE) in the MAC PDU may follow the DL-SCH MAC PDU format. No subheader may be encoded if the WTRU contention resolution identity is encoded as the first information in the MAC PDU (e.g., the 48 first bits in the MAC PDU). The WTRU Contention Resolution Identity may contain the UL CCCH SDU transmitted by the WTRU. If the UL CCCH SDU is longer than 48 bits, this field contains the first 48 bits of the UL CCCH SDU. The first subheader may indicate a feature to apply (e.g., repetition for the Msg4 PUCCH transmission (and/or a number of repetitions)).

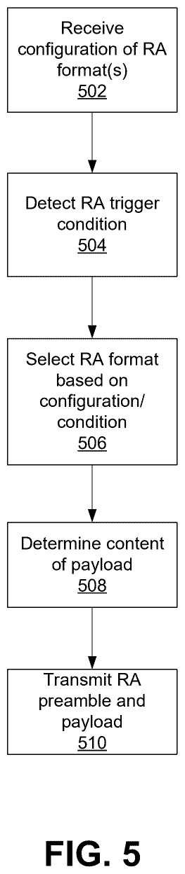

FIG. 5 illustrates an example procedure for indicating information in random access. As shown in FIG. 5, at 502, a WTRU may be configured with multiple random access (RA) Msg1 formats, a (e.g., each) Msg1 format including a preamble and a payload (e.g., small payload part). A (e.g., each) format may further be associated with a set of conditions. A (e.g., each) small payload part format may include one or more of, for example, payload size, payload encoding format, physical channel to be transmitted (e.g., PUSCH/PUCCH), etc. Small payload part format conditions may include one or more of, for example, WTRU type, WTRU connection state (e.g. RRC state), WTRU capabilities, RA trigger, amount of information to be indicated to the network, channel conditions (e.g., RSRP/RSRQ), etc.

At 504, the WTRU may detect an RA trigger condition (e.g., new data to transmit, paging receival, handover, etc.).

At 506, the WTRU may select the payload (e.g., small payload part) format based on the conditions and the configuration. For example, a small payload part format with minimum payload may be selected when the measured DL RSRP is below a configured threshold level. The WTRU may need to prioritize the information it indicates as part of the payload (e.g., small payload part). For example, the WTRU may prioritize information that may affect network decisions relating to the remainder of the RA procedure (e.g., Msg3 repetition requirement, WTRU capabilities to decode RAR, etc.). Each piece of information may be associated with a respective priority, and the WTRU may use the respective priorities to determine what to include in the payload (e.g., the content of the payload). A small payload part format for C-RNTI indication may be selected when the WTRU determines to be in CONNECTED mode and the RA trigger is for handover or UL data arrival.

At 508, the WTRU may determine the content of the payload (e.g., small payload part) based on the format and/or information to be indicated to the network. For example, the WTRU may encode its C-RNTI into the small payload part for the format used to indicate the C-RNTI. For example, the WTRU may encode a bitmap in the small payload part based on the information to be indicated, the information including, for example, Msg3 repetition request, Msg3 size (e.g., based on CCCH SDU size) requirement, device type, RRC state, type of access (e.g., SDT), etc.

The WTRU may select the RA and payload (e.g., small payload part) transmission resources based on one or more of: Applicable beams (e.g., in terms of beam channel conditions based on RSRP/RSRQ/etc.); a type of beam (e.g., SSB or CSI-RS based); the selected payload size for the small payload part; and/or the information to be indicated in the small payload part.

At 510, the WTRU may transmit the Msg1 (e.g., the RA preamble and associated payload (e.g., small payload part)), for example using the selected resources.

The WTRU may initiate an RA procedure based on a trigger condition (e.g., initial access, resume, scheduling request, beam failure, bursty/small data transmission, etc.).

Based on the trigger condition and/or at least one other condition, the WTRU may determine that certain information is applicable to the RA procedure and needs to be indicated to the network device during the RA procedure. The determining may be based on, e.g., the type of the device, channel conditions (e.g., RSRP, RSRQ, SINR), type of the access (e.g., initial access, resume, scheduling request, beam failure recovery, small/bursty data transmission, SI request, handover, etc.), potential payload size (e.g., for Msg3), requested service (e.g., specific network slice (set), Msg3 repetition request, etc.), or any other information.

Based on the determination, the WTRU selects a RA resource for Msg1 transmission, the Msg1 transmission including a preamble part and a small payload part. The small payload part may be encoded and transmitted over PUSCH or PUCCH resource and may be transmitted in TDM or FDM manner with the preamble. Such preambles used for the two-piece Msg1 may be distinct from the “Common RACH” which may be used for general RA (e.g., without additional information indicating). The small payload part may consist of, e.g., 1-3 bytes. The small payload part size may be configured by the network such that it may be (e.g., always) the same size (e.g., 2 bytes), or the WTRU may indicate the size of the small payload part. The WTRU indication may be based on the transmitted preamble (e.g., different preambles correspond to different payload size) or UCI (Uplink Control Information) may be encoded into the small payload part to indicate the actual payload size.

The WTRU may encode the small payload part with the information to be indicated to the network device. The small payload part may consist of a bitmap, a field with assignable indices, or both. Additionally, the small payload part may consist of reserved bits (e.g., for future use). The bitmap may be used to indicate one or more distinct pieces of information (e.g., at the same time). For example, the WTRU may indicate the requirement/request for Msg3 repetitions, a specific device type (e.g., XR or RedCap device), and/or type of the access (e.g., SDT), and may encode the bitmap accordingly. A field may be encoded where a certain index of the field indicates certain information. For example, the index of the field may indicate the state of the WTRU (e.g., CONNECTED or IDLE/INACTIVE). The index of the field may indicate the required payload size for the Msg3 (e.g., minimum of 56 bits, 72 bits, etc.). A field/bit may be encoded which indicates the format of the remainder of the small payload part. For example, the field/bit may indicate that the WTRU is a CONNECTED mode WTRU and the WTRU's C-RNTI is encoded in the remainder of the payload part. The WTRU may also generate a random number into the small payload part. The random ID may be, for example, a 1-5 bit long field. The NW may configure at least partly how the small payload is encoded by the WTRU (e.g., indicates the bitmap/index values to be used for specific information.

The WTRU may transmit the two-piece Msg1, start a RAR (Random Access Response) window, and/or start to monitor for RAR. The RAR window may be started immediately after the two-piece Msg1 transmission, after the preamble transmission, or after an offset time after the two-piece Msg1/preamble transmission. Additionally, the RAR window starting/monitoring may be based at least in part on the information indicated in the two-piece Msg1. For example, based on the information indicated in the two-piece Msg1, the WTRU may: decode the RAR window for a specific time duration; decode the RAR within a specific frequency (e.g., bandwidth part); decode a specific RNTI (Radio Network Temporary Identifier); and/or apply a specific bandwidth, etc. If the WTRU included C-RNTI in the small payload part of Msg1, the WTRU may monitor for the RAR based on the C-RNTI; otherwise, the WTRU may monitor for the RAR based on a RA-RNTI.

Upon receiving a RAR, the WTRU may determine if the RAPID (Random Access Preamble ID) it transmitted is included in the RAR PDU. Furthermore, upon determining that the transmitted RAPID is included in the RAR PDU, the WTRU may further determine additional information associated with the RAPID, the additional information corresponding to at least part of the information transmitted by the WTRU in the small payload part. The additional information may consist of: the random ID generated randomly by the WTRU into the small payload part; the small payload the WTRU transmitted in the Msg1 (e.g., NW echoes the whole small payload in the RAR); and/or part of the small payload the WTRU transmitted in the Msg1. If the WTRU included its C-RNTI in the small payload part of Msg1, the WTRU may decode C-RNTI for RAR, and upon receiving a PDCCH addressed to C-RNTI, the WTRU may determine the RAR reception and the whole RA procedure may successfully complete. The WTRU may expect to receive a DL assignment if the WTRU has no valid TA (Timing Alignment), and the WTRU may expect to receive UL grant if the WTRU has valid TA. If the WTRU includes its C-RNTI in the small payload part, the WTRU may decode corresponding RA-RNTI for RAR, and upon receiving the RAR MAC PDU with used RAPID, the WTRU may determine if the indicated TC-RNTI in the RAR payload corresponds to the indicated C-RNTI. If the TC-RNTI matches with the indicated C-RNTI, the WTRU may consider the RAR reception, contention resolution, and/or RA procedure successfully completed.

The WTRU may determine if the additional information corresponds to at least part of the information transmitted by the WTRU in the small payload part. If the WTRU determines that the additional information corresponds to at least part of the information transmitted by the WTRU in the small payload part, the WTRU may determine the RAR reception to be successful and may decode the actual RAR payload (e.g., which may consist of, for example, the Msg3 grant, TC-RNTI, Timing Advance Command, etc.). If the WTRU determines the additional information does not correspond to the information transmitted by the WTRU in the small payload part, the WTRU may determine RAR reception not successful and may initiate RA resource selection again. The small payload part may be stored in a buffer upon first transmission (e.g., “Msg1 buffer”, “small payload buffer”, etc.) and the same payload may be used for a (e.g., each) re-attempt. Alternatively, the small payload part may be (e.g., always) regenerated upon a (e.g., every) re-attempt.

The WTRU may transmit Msg3 based on the RAR content. The Msg3 may include further information to be indicated to the network during the RA procedure (e.g., Msg4 PUCCH ACK repetition request).

The WTRU may receive a contention resolution message. The contention resolution message may be addressed to the TC-RNTI assigned in the RAR and may provide a contention resolution ID matching at least in part the CCCH SDU transmitted by the WTRU in Msg3.

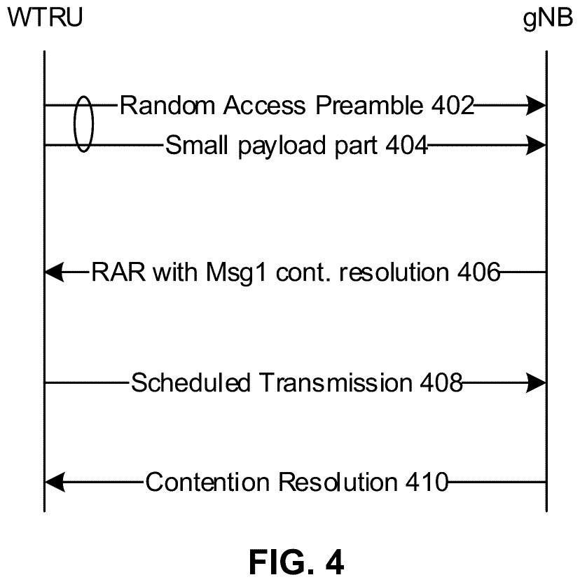

FIG. 4 illustrates an example proposed RA procedure. As shown in FIG. 4, the WTRU may transmit a two-piece Msg1 (e.g., which may include the random access preamble 402 and the payload (e.g., small payload part) 404) in RA procedure if it determines that information is applicable to the RA procedure and needs to be indicated to the network device during the RA procedure. The determination may be based on, e.g., the type of the device, channel conditions (e.g., RSRP, RSRQ, SINR), type of the access (e.g., initial access, resume, scheduling request, beam failure recovery, small/bursty data transmission, SI request, handover, etc.), potential payload size (e.g., for Msg3), requested service (e.g., specific network slice (set), Msg3 repetition request, etc.), and/or any other information. The WTRU may prioritize a first piece of information to be indicated over a second piece of information.

The two-piece Msg1 may consist of a preamble part 402 and a payload (e.g., small payload part) 404. The small payload part 404 may be encoded and transmitted over PUSCH or PUCCH resource. The preamble part 402 and small payload part 404 may be transmitted in TDM or FDM manner. The preambles used for the two-piece Msg1 may be distinct from the “Common RACH” which is used for general RA (e.g., without additional information indicating). The small payload part may consist of, e.g., 1-3 bytes. The small payload part 404 size may be configured by the network, and may be (e.g., always) the same size (e.g., 2 bytes), or the WTRU may indicate the size of the small payload part 404. The WTRU indication may be based on the transmitted preamble 402 (e.g., different preambles correspond to different payload size), or UCI (Uplink Control Information) may be encoded into the small payload part 404 to indicate the actual payload size.

The payload (e.g., small payload part) 404 may consist of a bitmap, a field with assignable indices, or both. Additionally, the small payload part 404 may consist of reserved bits (e.g., for the first release). The bitmap may be used to indicate one or more distinct pieces of information (e.g., at the same time). For example, the WTRU may indicate the requirement/request for Msg3 repetitions, a specific device type (e.g., XR or RedCap device), and type of the access (e.g., SDT), and may encode the bitmap accordingly.

A field may be encoded where certain index of the field indicates certain information. For example, the index of the field may indicate the state of the WTRU (e.g., CONNECTED or IDLE/INACTIVE). The index of the field may indicate the required payload size for the Msg3 (e.g., minimum of 56 bits, 72 bits, etc.). A field/bit may be encoded which indicates the format of the remainder of the small payload part 404. For example, the field/bit may indicate that the WTRU is a CONNECTED mode WTRU, and the WTRU's C-RNTI may be encoded in the remainder of the payload part. The WTRU may generate a random number into the small payload part 404. The random ID may be, for example, a 1-5 bit long field. The NW may configure at least partly how the small payload part 404 is encoded by the WTRU (e.g., the network may indicate the bitmap/index values).

After transmitting the two-piece Msg1, the WTRU may monitor for RAR 406 during the RAR window. The monitoring of the RAR window may be based at least in part on the information indicated in the two-piece Msg1. For example, based on the information indicated in the two-piece Msg1, the WTRU may: decode the RAR window for a specific time duration; decode the RAR within a specific frequency (e.g., bandwidth part); decode a specific RNTI (Radio Network Temporary Identifier); and/or apply a specific bandwidth, etc. Upon receiving a RAR 406, the WTRU may determine if the RAPID (Random Access Preamble ID) it transmitted is included in the RAR PDU. Upon determining that the transmitted RAPID is included in the RAR PDU, the WTRU may further determine additional information associated with the RAPID, the additional information corresponding to at least part of the information transmitted by the WTRU in the small payload part 404. The additional information may consist of the random ID generated randomly by the WTRU into the payload (e.g., small payload part) 404. The additional information may consist of the small payload 404 the WTRU transmitted in the Msg1 (e.g., NW echoes the whole small payload 404 in the RAR). The additional information may consist of part of the (e.g., small) payload 404 the WTRU transmitted in the Msg1.

If the WTRU determines the additional information does not correspond to the information transmitted by the WTRU in the small payload part, the WTRU may determine RAR reception not successful and may initiate RA resource selection again. The small payload part 404 may be stored in a buffer upon first transmission (e.g., “Msg1 buffer”, “small payload buffer”, etc.) and the same payload 404 may be used for a (e.g., each) re-attempt. Alternatively, the small payload part 404 may be (e.g., always) regenerated upon a (e.g., every) re-attempt.

If the WTRU determines the additional information corresponds to at least part of the information transmitted by the WTRU in the small payload part 404, the WTRU may determine the RAR reception successful and may decode the actual RAR payload (e.g., which may consist of the Msg3 grant, TC-RNTI, Timing Advance Command, etc.). If the WTRU included its C-RNTI in the small payload part of Msg1, the WTRU may decode C-RNTI for RAR and upon receiving a PDCCH addressed to C-RNTI, the WTRU may determine the RAR reception and the whole RA procedure successfully completed. The WTRU may expect to receive DL assignment if the WTRU has no valid TA, and the WTRU may expect to receive UL grant if the WTRU has a valid TA.

The WTRU may transmit Msg3 408 based on the RAR 406. For example, the Msg3 may include further information to be indicated to the network during the RA procedure (e.g., Msg4 PUCCH ACK repetition request).

The WTRU may receive a contention resolution message 410. For example, the contention resolution message 410 may be addressed to the TC-RNTI assigned in the RAR and may provide a contention resolution ID matching at least in part the CCCH SDU transmitted by the WTRU in Msg3 408.

Various pieces of information about the WTRU device type, type of access, feature, capabilities, etc. may be transmitted in Msg1 without extensive preamble partitioning.

Methods or encoding UL MAC PDUs in RA procedures may be disclosed herein.

The WTRU (e.g., or the MAC entity of the WTRU) may encode MAC PDU(s) transmitted as part of a RA procedure (e.g., differently from the UL-SCH MAC PDU). A MAC PDU may be transmitted as Msg3 after receiving a RAR (e.g., with 4-step RA procedure) or as MsgA PUSCH (e.g., with 2-step RA procedure).

A (e.g., the first) subheader in the MAC PDU may have a specific format. Any other subheader following the first subPDU (e.g., MAC subheader +SDU/CE) in the MAC PDU may follow the UL-SCH MAC PDU format.

The specific format may consist of a field indicating whether a CCCH SDU or a C-RNTI MAC CE is encoded in the subPDU (e.g., follows the subheader). The field may be 1 bit (e.g., indicating either CCCH SDU or C-RNTI MAC CE). The field may be 2 bits (e.g., indicating either C-RNTI MAC CE or different sizes of CCCH SDU (e.g., 48 bits or 64 bits CCCH SDU)). The remaining (e.g., one) index may be reserved or may indicate a subheader extension if C-RNTI MAC CE is included in the subPDU. The remaining (e.g., one) index may indicate that the C-RNTI MAC CE precedes/follows with additional information, like security information (e.g., MAC-I or short MAC-I). The specific format may consist of a field or bitmap indicating different information to the NW. The information may consist of one or more of the following: the field or the bitmap may indicate device type, repetition request for Msg4 PUCCH ACK/Msg5, small CSI, etc.; the field may indicate a CCCH SDU extension (e.g., 4-6 additional bits of the subheader may be used as CCCH SDU information extension which may indicate, e.g., a part of the WTRU ID, access cause, capabilities, etc.); and/or the field or the bitmap may be encoded differently based on whether the CCCH SDU or the C-RNTI MAC CE is included in the subPDU. For example, if a C-RNTI MAC CE is included in the subPDU, one or more fields or bitmaps may indicate the RA cause (e.g., BFR, SR/BSR, SR failure, HO, etc.).

For example, the subheader may be as shown in FIG. 3, and may be a first subheader. The SDU type 304 shown in FIG. 3 may indicate the C-RNTI, CCCH SDU (with different sizes), etc. The R bits 303 shown in FIG. 3 may be used for the field or the bitmap. The subheader 300 may include a CCCH extension field 305.

The first subheader in the MAC PDU used by the NW for contention resolution (e.g., Msg4 in 4-step RA procedure or MsgB in 2-step RA procedure) may have a specific format. For example, the MAC PDU addressed to TC-RNTI assigned during the RA procedure may have the specific format for the first subheader in the MAC PDU (e.g., when 4-step RA procedure is used). The MAC PDU addressed to RA/MSGB-RNTI derived based on the transmitted MSGA (e.g., based on preamble or the PUSCH resource or both) may have the (e.g., specific) format for the first subheader in the MAC PDU (e.g., when 2-step RA procedure is used). Any other subheader following the first subPDU (e.g., MAC subheader +SDU/CE) in the MAC PDU may follow the DL-SCH MAC PDU format. No subheader may be encoded, in which case the WTRU contention resolution identity may be encoded as the first information in the MAC PDU (e.g., the 48 first bits in the MAC PDU). For example, the WTRU Contention Resolution Identity may contain the UL CCCH SDU transmitted by the WTRU. If the UL CCCH SDU is longer than 48 bits, this field may contain the first 48 bits of the UL CCCH SDU. The first subheader may indicate a feature to apply (e.g., repetition for the Msg4 PUCCH transmission (and number of repetitions)).

Methods for encoding RAR MAC PDUs in an RA procedure may be disclosed herein. One or more of the embodiments disclosed herein may support future proof RA procedure combining 2-step and 4-step procedures and may facilitate RNTI space consumption for RA-RNTI.

An extendible RAR MAC PDU format may be introduced where both the RAR subheader as well as the payload (e.g., or at least the payload) may have a flexible length.

The RAR subheader may include a field indicating the RAR payload size. For example, the field could be 1 or 2 bits long indicating 2 or 4 RAR payload sizes, respectively.

The RAR subheader may be 1 or 2 bytes long depending on an indication in the RAR subheader. The indication may be a field indicating a subheader type. For example, a 2-bit field may indicate 4 different subheader formats: RAPID only (e.g., for 2-step fallbackRAR or 4-step RAR); RO indication; SuccessRAR/Padding; 2-byte subheader; etc. For RO indication, the RARs after the RO indication may be (e.g., all) for that RO until a second RO indication is encoded in the RAR MAC PDU, or end of the MAC PDU is reached. BI may also follow this indication to apply BI per RO. A default RAR format and/or size may be defined (e.g., for the RAPID only case). For example, the RAR subheader formats may be as shown in FIG. 2.

As shown in FIG. 2, the term “SH type 201” may indicate the type of the subheader in RAR: subheader 200 with a “default” RAR/fallbackRAR with fixed RAR size which indicates the preamble ID 202 and the default size RAR payload; an ROI (RO indicator) 205 subheader 210 with possible backoff indicator (BI) 204 per RO (e.g., 1 or 2 byte subheader depending on BI 204); a subheader 220 with a different length (or type) RAR size based on LI (Length Indicator) 207 which may then include either RAR/fallbackRAR or successRAR (FS) 208; and/or a padding/“default” successRAR subheader 230 where a PS (padding/success) bit 212 may indicate which is encoded.

For ROI (RO indicator) 205 subheader 210 with possible backoff indicator (BI) 204 per RO, if BI 204 indicates presence of the Backoff field 206 for this RO, the second byte may be encoded. The ROI 205 may indicate the frequency domain RO index of a PRACH timeslot. Additionally/alternatively, the ROI 205 or an additional field may indicate the UL carrier used to transmit the PRACH. The subheader 210 may include one or more reserved (R) bits 203.

For subheader 220 with a different length (or type) RAR size based on LI (Length Indicator) 207 which may then include either RAR/fallbackRAR or successRAR (FS) 208, if successRAR is encoded based on FS 208, then the second byte may not be encoded. The LI 207 may indicate different RAR payload sizes, where the size values may depend on whether the RAR is a successRAR, fallbackRAR, or normal RAR. The RAR payload sizes may be the same for RAR and fallbackRAR. The subheader 220 may include one or more reserved (R) bits 203 and/or an S bit 209 indicating possible SDUs, and/or a preamble ID 202.

For padding/“default” successRAR subheader 230 where a PS (padding/success) bit 212 may indicate which is encoded, “S” bit 209 shown in FIG. 2 may indicate possible SDU(s) following the successRAR (e.g., as in legacy). The “L” field 211 may follow (e.g., or is indicated to follow) the first byte in case SDU(s) to multiple WTRUs are encoded in the RAR MAC PDU. The subheader 230 may include one or more reserved (R) bits 203 and/or an S bit 209 indicating possible SDUs, and/or a preamble ID 202.

1. A wireless transmit/receive unit (WTRU) comprising a processor configured to:
receive, from a network, configuration information of one or more random access (RA) formats, wherein each RA format is associated with a respective preamble and a respective payload;
detect an RA trigger condition;
select, based on one or more of the detected RA trigger condition or the received configuration, an RA format of the one or more RA formats;
determine a content of the payload associated with the selected RA format; and
transmit, to the network, the preamble and the payload associated with the selected RA format.

2. The WTRU of claim 1, wherein the processor is further configured to:
select transmission resources for the preamble and the payload;
wherein the preamble and the payload associated with the selected RA format are transmitted using the selected transmission resources.

3. The WTRU of claim 2, wherein the transmission resources are selected based on one or more of: applicable beams, a type of beam, a size of the payload, or information to be indicated in the payload.

4. The WTRU of claim 1, wherein the RA trigger condition comprises one or more of new data determined by the WTRU to transmit, a paging receival, or a handover.

5. The WTRU of claim 1, wherein each RA format of the one or more RA formats is associated with one or more of: a respective payload size, a respective payload encoding format, or a respective physical channel.

6. The WTRU of claim 5, wherein the processor is configured to determine that a measured downlink (DL) reference signal received power (RSRP) is below a threshold, wherein the RA format of the one or more RA formats is selected based on the RA format having a minimum payload size among the one or more RA formats.

7. The WTRU of claim 1, wherein the processor is configured to determine the content of the payload associated with the selected RA format based on respective priorities of pieces of information to be included in the payload.

8. The WTRU of claim 1, wherein the one or more RA formats are Msg1 formats.

9. The WTRU of claim 1, wherein the content of the payload comprises one or more of a Cell Radio Network Temporary Identifier (C-RNTI) associated with the WTRU, a Msg3 repetition request, a Msg3 size requirement, a device type associated with the WTRU, an RRC state associated with the WTRU, or a type of access.

10. The WTRU of claim 1, wherein the content of the payload comprises a bitmap.

11. A method implemented in a wireless transmit/receive unit (WTRU), the method comprising:
receiving, from a network, configuration information of one or more random access (RA) formats, wherein each RA format is associated with a respective preamble and a respective payload;
detecting an RA trigger condition;
selecting, based on one or more of the detected RA trigger condition or the received configuration, an RA format of the one or more RA formats;
determining a content of the payload associated with the selected RA format; and
transmitting, to the network, the preamble and the payload associated with the selected RA format.

12. The method of claim 11, further comprising:
selecting transmission resources for the preamble and the payload;
wherein the preamble and the payload associated with the selected RA format are transmitted using the selected transmission resources.

13. The method of claim 12, wherein the transmission resources are selected based on one or more of: applicable beams, a type of beam, a size of the payload, or information to be indicated in the payload.

14. The method of claim 11, wherein the RA trigger condition comprises one or more of: new data determined by the WTRU to transmit, a paging receival, or a handover.

15. The method of claim 11, wherein each RA format of the one or more RA formats is associated with one or more of: a respective payload size, a respective payload encoding format, or a respective physical channel.

16. The method of claim 15, further comprising determining that a measured downlink (DL) reference signal received power (RSRP) is below a threshold, wherein the RA format of the one or more RA formats is selected based on the RA format having a minimum payload size among the one or more RA formats.

17. The method of claim 11, wherein the content of the payload associated with the selected RA format is determined based on respective priorities of pieces of information to be included in the payload.

18. The method of claim 11, wherein the one or more RA formats are Msg1 formats.

19. The method of claim 11, wherein the content of the payload comprises one or more of a Cell Radio Network Temporary Identifier (C-RNTI) associated with the WTRU, a Msg3 repetition request, a Msg3 size requirement, a device type associated with the WTRU, an RRC state associated with the WTRU, or a type of access.

20. The method of claim 11, wherein the content of the payload comprises a bitmap.
